(19) United States
(12) Patent Application Publication
(10) Pub. No.: US 2008/0163190 A1
(43) Pub. Date: Jul. 3, 2008

(54) Firmware Update Method And Update Program

(75) Inventors: Tomoo Shirota, Kawasaki (JP); Teruo Satou, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/863,358

(22) Filed: Sep. 28, 2007

(30) Foreign Application Priority Data
Dec. 27, 2006 (JP) 2006-353506

(51) Int. Cl. G06F 9/44; G06F 1/00

(52) U.S. Cl. 717/170; 713/300

(57) ABSTRACT

In a storage device including a processor, the validity of data, which is stored in the storage device and does not include firmware used by the processor, is verified, and the firmware is updated while backing up the data, the validity of which is verified, with a battery connected to the storage device.

### BACKGROUND OF THE INVENTION

1. Field of the Invention

The present invention relates to a method for a version change such as a version upgrade of firmware, and more particularly, to a method for the version changes of firmware respectively comprised, for example, in a cluster within a disk control device, and within a semiconductor storage device.

2. Description of the Related Art

As a system targeted by the present invention, for example, a data storing system configured with a main body device comprising a plurality of clusters, and a plurality of external storage devices each comprising a semiconductor memory is considered. Here, each of the clusters on the side of the main body device is assumed to be freely accessible to each of the plurality of external storage devices such as system storage units (SSUs). Each of the clusters and each of the SSUs respectively comprise a service processor (SVP) for monitoring the inside of each device by using firmware, and the SVPs of the clusters and SVSs of the SSUs are adapted to be able to communicate with one another, for example, via a LAN (Local Area Network). Here, the firmware used by the SVP of each of the SSUs is intended to control, for example, the state of memory device.

If the need for a version change such as a version upgrade of firmware used by each SVP of each of the clusters and each of the SSUs arises in such a memory system, data stored in an internal memory etc. on the cluster side, and stored user data, etc. on the external storage device side are saved in a direct access storage device (DASD) such as a hard disk drive, etc., and the version change of the firmware can be made in a completely stopped state.

FIG. 1 is a flowchart showing the process of such a conventional firmware version change method. Once the process is started in FIG. 1, data is initially saved in DASD in correspondence with, for example, an operation performed by an operator of a system in step S101. Then, in step S102, a running operating system is stopped, and the system is completely stopped. Next, in step S103, it is determined whether or not data such as user data, which is stored in each SSU, is invalidated. If the data is not invalidated, it is recognized that the data is not saved properly, and the version change of firmware is aborted in step S104.

If the data stored in each SSU is invalidated, an instruction to make the version change of the firmware is issued from the operator, for example, to a master SSU among the plurality of SSUs in step S105. Then, in step S106, a request to check whether or not the version changes of firmware can be simultaneously made is issued from the master SSU to each cluster and each SSU. This request is a request to check whether or not to be able to make a version change from a current active system version to a current standby system version by newly using the standby system version as the active system version, for example, if each cluster and each SSU have two versions of firmware, one being for the active system and one being for the standby systems. In step S107, whether or not the version change of the firmware can be made is determined according to reports from each cluster and each SSU. If the version change cannot be made, a display such that the version change cannot be made is made as a result of the check in step S108.

If it is determined that the version changes of the firmware can be simultaneously made, each cluster and each SSU are powered off by the operator in step S109, and, for example, wiring to a ROM (Read Only Memory) which stores the firmware of the standby system version is switched to wiring to a ROM which stores the firmware of the active system version. Then, in step S110, each cluster and each SSU are powered on. In step S111, the firmware the version change of which is made enters an in-use state. In step S112, the user data, etc. are restored, and the process is terminated.

As described above, the version change of firmware is conventionally made after, for example, the whole of user data, etc. stored in an external storage device is saved in DASD. However, since the amount of user data, etc. stored within SSU is very large in normal cases, there has been a problem that it takes a lot of time to save the user data, etc. in DASD, etc., and an actual stoppage time of the system, which is required for the version change of firmware, becomes long.

As conventional techniques for making such a version upgrade of a program, or for adding a processor as hardware without stopping a system, Patent Documents 1 and 2 exist.

Patent Document 1 discloses a technique with which the non-stoppage maintenance of a disk control device can be made by changing a set of clusters, which can make a data transfer for each volume, while imposing a restriction such that a data transfer is made only between a cluster and a volume only if a match is found between the version number of the cluster of the disk control device and the version number of the volume as a logical unit of data recording.

Patent Document 2 discloses an online processor adding method for adding a communication processor without stopping a system in a multi-processor system where a plurality of communication processors are provided for one management processor, and for enabling an immediate shift to an old version if an abnormality is found after adding the communication processor.

[Patent Document 1] Japanese Published Unexamined Patent Application No. H6-309117 “Non-stoppage Maintenance Method for Disk Control Device, and Disk Control Device”

[Patent Document 2] Japanese Published Unexamined Patent Application No. HS-324591 “Online Processor Adding Method”

These conventional techniques, however, cannot solve the problem that the actual stoppage time of a system becomes long due to the saving of user data, etc. stored in an external storage device at the time of the version change of firmware.

### SUMMARY OF THE INVENTION

An object of the present invention is to improve the timewise use efficiency of a data storing system, which is configured, for example, with a plurality of clusters and a plurality of external storage devices, by reducing a time during which the system must be stopped to a minimum with the shortening of an operation time required for updating firmware, in light of the above described problems.

A firmware update method according to the present invention is an update method for firmware in a storage device including a processor. As this method, the validity of data, which is stored in the storage device and does not include a piece of firmware used by the processor, is initially verified. Next, the piece of the firmware is updated while keeping the storage device, the data validity of which is verified, in a backup state with a battery connected to the storage device.

Additionally, the firmware update method according to the present invention can be an update method further updating a second piece of firmware simultaneously with the piece of the firmware used by the processor of the storage device, wherein the second piece of the firmware is comprised on a computer side that exchanges data with the above described storage device.

With this method, the second piece of the firmware on the computer side is verified that the updates of the piece of the firmware used by the processor of the storage device and the second piece of the firmware on the computer side can be made simultaneously prior to the update of the firmware used by the processor of the storage device, after the above described data validity is verified.

As described above, according to the present invention, the validity of data is verified and the firmware is updated while backing up the valid data with the use of a battery without saving the data, such as user data, which is stored in a storage device and does not include firmware.

According to the present invention, the firmware can be updated while keeping the valid state of user data, etc. with a battery backup without saving the user data, etc. stored in an external storage device, for example, in another storage device such as a hard disk drive, etc. Therefore, according to the present invention, an operation time required for updating firmware is shortened, and an actual time required to stop a system can be significantly reduced.

### BRIEF DESCRIPTION OF THE DRAWINGS

FIG. 1 is a flowchart showing the process of a conventional firmware version change method;

FIG. 2 is a functional block diagram showing the principle of a firmware version change method according to the present invention;

FIG. 3 is a block diagram showing the basic configuration of a data storing system to which the firmware version change method according to the present invention is applied;

FIG. 4 is a block diagram showing the configuration of a duplex data storing system;

FIG. 5 is a flowchart showing the process of the firmware version change method according to one preferred embodiment;

FIG. 6 is a schematic explaining a method for a check request issued from an operator to a mater SSU; and

FIG. 7 is a schematic explaining a method for reporting a check result from the master SSU to the operator.

### DESCRIPTION OF THE PREFERRED EMBODIMENTS

One example of an update is a version change, which is described below.

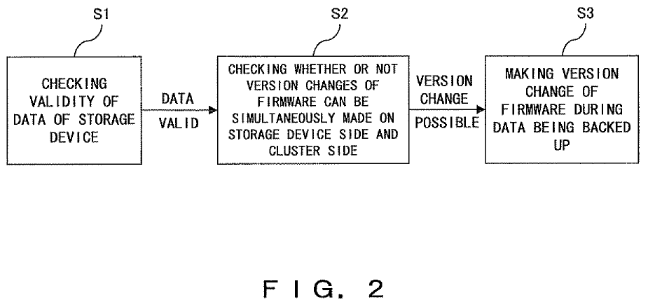

FIG. 2 is a functional block diagram showing the principle of a firmware version change method according to the present invention. According to the present invention, the version change of used firmware is made in a data storing system configured, for example, with a plurality of clusters and a plurality of external storage devices.

In FIG. 2, firstly in step S1, the validity of data such as user data, which is stored in each of the external storage devices, is checked. Unlike conventional techniques, this check is made to verify the validity of data such as user data, which is stored in each of the external storage devices, prior to the version change of firmware in order for the version change of the firmware without saving the data stored in each of the external storage devices, according to the present invention.

After the validity of the data is verified, it is checked in step S2 whether or not to be able to simultaneously change the versions of pieces of firmware which are to be simultaneously changed, wherein the respective pieces of the firmware are comprised respectively in the external storage devices and the clusters. For example, if two pieces of firmware of two versions corresponding to an active system and a standby system are comprised in each of the external storage devices and each of the clusters, it is determined whether or not to be able to make a version change from the firmware of the active system to that of the standby system in each of the external storage devices and each of the clusters.

If it is verified that the version changes of the firmware can be simultaneously made in each of the clusters and each of the external storage devices, the version changes of firmware are simultaneously made while keeping data stored in each of the external storage devices in a backup state with a battery in step S3.

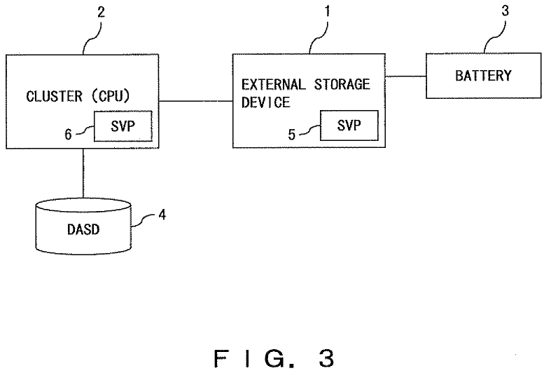

FIG. 3 is a block diagram showing the basic configuration of a data storing system using the firmware version change method according to the present invention. In this figure, an external storage device 1 (semiconductor memory) is connected to a cluster 2 including a CPU. Additionally, a battery 3 for protecting memory contents stored in the semiconductor memory even if the power of the external storage device 1 is shut off is connected to the external storage device 1. Furthermore, DASD 4 such as a hard disk drive, etc., to which memory contents such as those stored in the local memory within the cluster 2 are saved depending on need, is connected to the cluster 2. Still further, the external storage device 1 and the cluster 2 includes, for example, service processors (SVPs) 5 and 6, which run with firmware. These SVPs can communicate with each other, for example, via a LAN.

The SVP 5 within the external storage device 1, and the SVP 6 within the cluster 2 respectively monitor each device within the external storage device 1 and the cluster 2, and respectively comprise firmware for their monitoring, etc. The version changes of pieces of the firmware respectively comprised in the SVPs 5 and 6 must be simultaneously made.

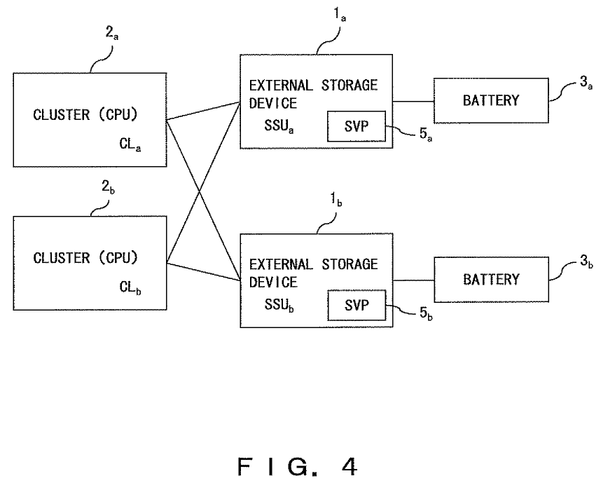

FIG. 4 is a block diagram showing the configuration of a data storing system in order to specifically explain one preferred embodiment. In FIG. 4, two external storage devices such as semiconductor memories 1ₐ, 1_{b}, and two clusters 2ₐ, 2_{b} are comprised, and the two external storage devices and the two clusters are interconnected, in this system. The two external storage devices, namely, SSUₐ and SSU_{b} are shared by the two clusters, namely, CLₐ and CL_{b}. When either of the clusters writes data to SSU, the data is simultaneously written to the two SSUs. Namely, this data storing system is a duplex system.

The external storage devices 1ₐ and 1_{b} respectively include service processors (SVPs) 5ₐ and 5_{b}. Additionally, batteries 3ₐ and 3_{b} are respectively connected to the two external storage devices 1ₐ and 1_{b}. Even if the power of the external storage devices 1ₐ and 1_{b} is shut off, user data, etc. stored within the respective storage devices is backed up with the batteries.

Also the clusters 2ₐ and 2_{b} respectively include SVPs not shown, and these SVPs respectively comprise firmware for operations similar to the SVPs 5ₐ and 5_{b} within the external storage devices. As the firmware, two versions of firmware, one being for an active system and one being for a standby system, are comprised for each of the SVPs. If the version change of firmware is made, a new version is provided to the standby system, and switching is made to the new version according to a switching instruction issued from, for example, an operator of the system.

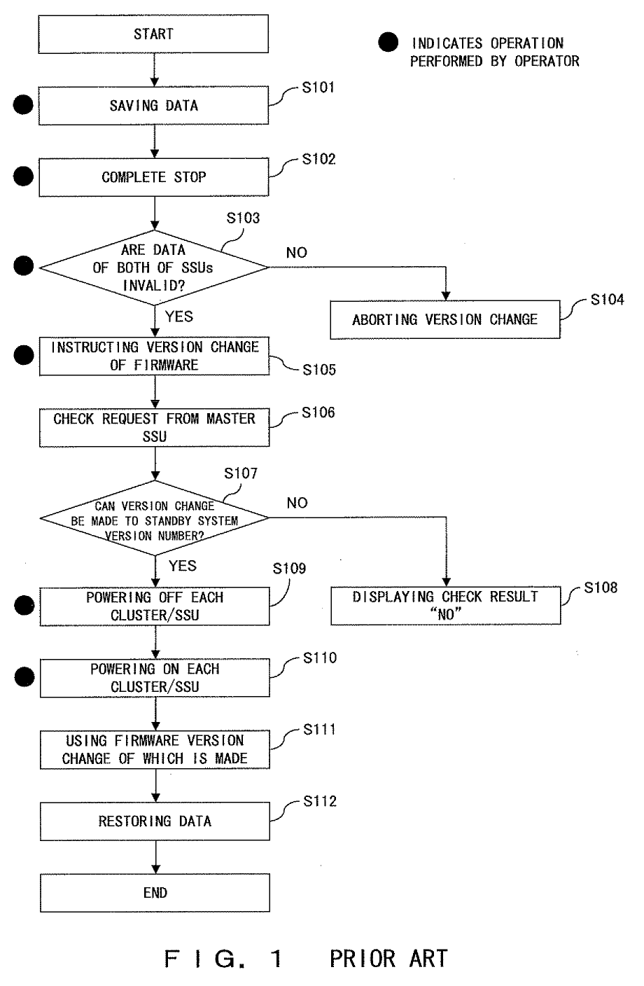

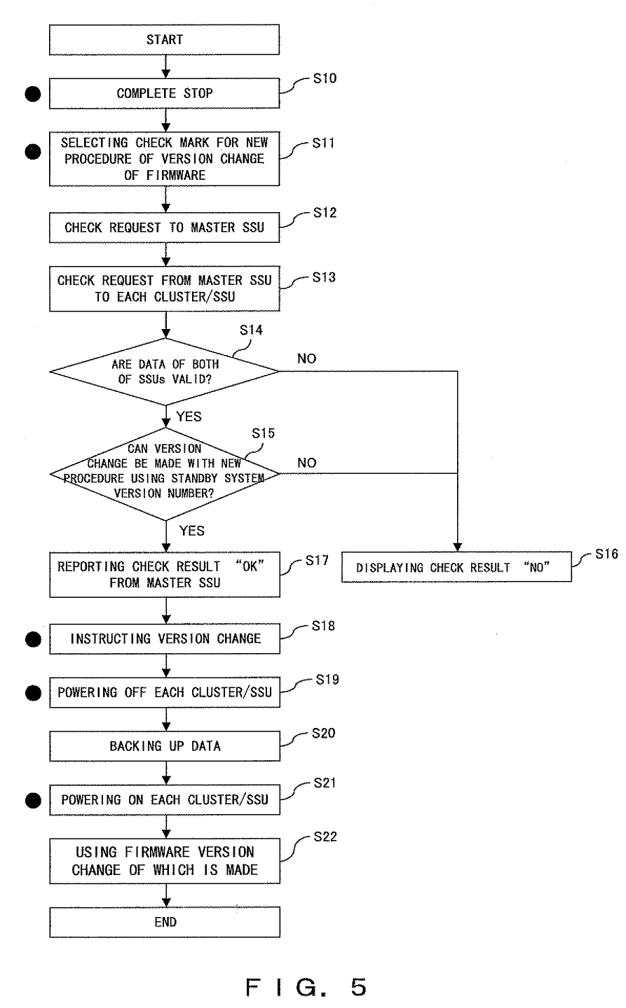

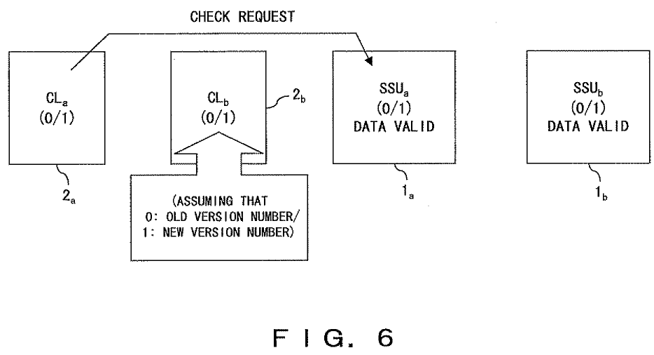

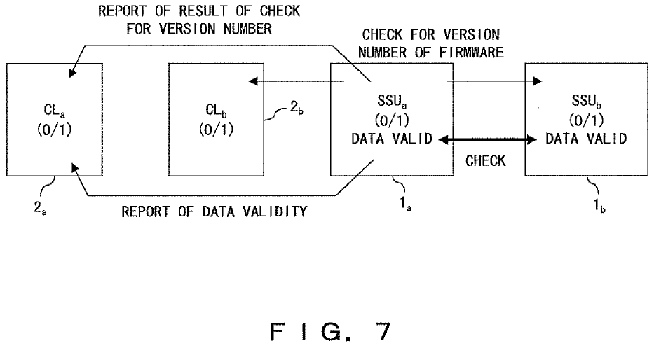

FIG. 5 is a flowchart showing a firmware version change process according to one preferred embodiment. The flowchart shown in FIG. 5 is described with reference to FIGS. 6 and 7, which explain operations performed between each cluster and each SSU, and in comparison with FIG. 1 which explains the conventional example.

Once the process is started in FIG. 5, an operating system that has run is initially stopped, for example, by an operator of the system, and the system is completely stopped in step S10. Comparing with FIG. 1, a difference exists in a point that user data, etc. stored in an external storage device is not saved before the system is completely stopped.

Then, in step S11, a check mark for a new procedure of the version change of firmware is selected, for example, on a display screen of the cluster CLₐ, for example, by the operator. Next, in step S12, a check request is issued from the cluster CLₐ to an SVP (master processor), for example, within the SSUₐ as a master SSU as shown in FIG. 6. Then, in step S13, the check request is issued to each cluster and each SSU as shown in FIG. 7.

Namely, as shown in FIG. 7, the check request is issued from the SSUₐ to the SVPs of the SSU_{b} as another SSU, and the clusters CLₐ and CL_{b}. Here, contents of the check request are a check for the validity of data and a check for the version number of firmware of the standby system, for example, “1” as a new version number for the SSU_{b}, and a check for the version number of firmware of the standby system for the cluster CLₐ. The check for the version number of firmware within the cluster CLₐ is made by the SVP of the CLₐ.

In step S14 of FIG. 5, it is determined whether or not data within the SSUₐ, which issues the request to check the validity of data, and data within the SSU_{b}, to which that request is issued, are valid. If both of the data are valid, it is determined in step S15 whether or not the version number of firmware, which corresponds to the standby system, is available as firmware after a version change made with the new procedure as the procedure in this preferred embodiment. If the version number is available, the result of the check is reported from the SVP of the SSUₐ to the SVP of the CLₐ as shown in FIG. 7.

If either or both of the data within the two SSUs is not valid in step S14, or if the version change of firmware cannot be made in step S15, a display indicating that the version change of firmware cannot be made is made as a result of the check in step S16.

If, in step S17, it is reported from the SSUₐ to the CLₐ as shown in FIG. 7 that the result of the check is proper, and if the result of the check for the version number of the firmware within the CLₐ, the check being made by the SVP of the CLₐ, is proper, an instruction to change the version of the firmware is issued, for example, from an operator to the CLₐ in step S18 of FIG. 5. Then, each cluster and each SSU are powered off in step S19.

As described with reference to FIG. 4, the batteries 3ₐ and 3_{b} are respectively connected to the two external storage devices 1ₐ and 1_{b}. Due to this configuration, stored user data, etc. is in a state being backed up (i.e., in a backup state) in step S20 of FIG. 5 even if each of the external storage devices is powered off. During the backup state in step S20, switching of connection is made to wiring, for example, to a read only memory (ROM) which stores firmware of a new version. Then, each cluster and each SSU are powered on in step S21. As a result, the firmware the version change of which is made becomes available in step S22, and the process is terminated.

What is claimed is:

1. A firmware update method for use in a storage device including a processor, comprising:
verifying validity of data, which is stored in the storage device and does not include a piece of firmware used by the processor; and
updating of the piece of the firmware while keeping the data, the validity of which is verified, in a backup state with a battery connected to the storage device.

2. The firmware update method according to claim 1, further comprising:
updating a second piece of firmware simultaneously with the piece of the firmware used by the processor of the storage device, wherein the second piece of the firmware is comprised on a computer side that exchanges data with the storage device;
wherein the second piece of the firmware on the computer side is verified that updates of the piece of the firmware used by the processor of the storage device and the second piece of the firmware on the computer side can be made simultaneously prior to the update of the firmware used by the processor of the storage device, after the validity of the data is verified.

3. A firmware update method for use in a data storing system where a plurality of storage devices respectively including processors, and a plurality of computers respectively exchanging data with the plurality of the storage devices are interconnected, comprising:
instructing, by a master processor among the processors respectively included in the plurality of the storage devices, each of the processors included in the plurality of the storage devices, verifying validity of data, which is stored in each of the plurality of the storage devices and does not include firmware used by each of the processors;
instructing, by the master processor, each of the processors included in the plurality of the storage devices and each of the plurality of the computers verifying whether or not to be able to simultaneously update firmware used by each of the processors included in the plurality of the storage devices, and firmware which is comprised by each of the plurality of the computers and which is to be updated simultaneously with the firmware used by each of the processors; and
updating of the firmware used by each of the processors included in the plurality of the storage devices, and the firmware comprised by each of the plurality of the computers if the validity of the data is verified, and the simultaneous updating of the firmware are verified to be possible.

4. A computer-readable storage medium on which is recorded a program, which is used by a processor included in a storage device in a system configured with the storage device including the processor, and a computer exchanging data with the storage device, and causes the processor to execute a process, the process comprising:
verifying validity of data, which is stored in the storage device and does not include firmware used by the processor, in correspondence with an instruction from an operator of the system;
checking whether or not to be able to simultaneously update firmware comprised on a side of the computer exchanging data with the storage device, and firmware used by the processor included in the storage device; and
reporting to the operator that the validity of the data is verified, and the updating of the firmware can be simultaneously made.

5. A storage device, comprising:
a first power supply unit supplying power;
a second power supply unit supplying power as a replacement for said first power supply unit, when said first power supply unit is stopped;
a first storage unit storing firmware;
a second storage unit holding data other than the firmware;
an examining unit examining the data held in said second storage unit; and
a control unit updating the firmware stored in said first storage unit while keeping the data, validity of which is verified by said examining unit, in said second storage unit by stopping a power supply from said first power supply unit, and by starting a power supply from said second power supply unit.
